(19) United States
(12) Patent Application Publication
(10) Pub. No.: US 2025/0322675 A1
(43) Pub. Date: Oct. 16, 2025

(54) REDUCING FALSE-NEGATIVES IN 3D OBJECT DETECTION VIA MULTI-STAGE TRAINING

(71) Applicant: NVIDIA Corporation, Santa Clara, CA (US)

(72) Inventors: Yilun Chen, Shatin (HK); Zhiding Yu, Cupertino, CA (US); Shiyi Lan, Sunnyvale, CA (US); Anima Anandkumar, Pasadena, CA (US); Jose M. Alvarez Lopez, Mountain View, CA (US)

(21) Appl. No.: 18/637,288

(22) Filed: Apr. 16, 2024

(51) Int. Cl. G06V 20/64; G06V 10/34; G06V 10/764; G06V 10/774; G06V 10/778; G06V 20/58

(52) U.S. Cl. CPC G06V 20/64; G06V 10/34; G06V 10/764; G06V 10/774; G06V 10/778; G06V 20/58

(57) ABSTRACT

3D objection detection is a computer vision task that generally refers to detecting (e.g. classifying and localizing) an object in 3D space from an image or video that captures the object. This computer vision task has many useful applications, such as autonomous driving applications which rely on the detection of 3D objects in a local environment to make autonomous driving decisions. State-of-the-art 3D object detectors generally rely on machine learning, but current training processes for these detectors do not specifically address false negative detections, or missed objects, which are often caused by occlusions and/or cluttered backgrounds in the given image/video. Reducing false negatives is crucial for many downstream applications, particularly autonomous driving applications which rely on accurate detection of obstacles for making safe driving decisions. The present disclosure provides for a multi-stage training process that reduces false negative detections by 3D object detectors.

### TECHNICAL FIELD

The present disclosure relates to the three-dimensional (3D) object detection.

### BACKGROUND

3D objection detection is a computer vision task that generally refers to detecting an object in 3D space from an image or video that captures the object. 3D object detection typically includes both classifying the object and localizing the object. This computer vision task has many useful applications, such as autonomous driving applications which rely on the detection of 3D objects in a local environment to make autonomous driving decisions.

State-of-the-art 3D object detectors generally rely on machine learning and are sensor-based, such as Lidar-based, camera-based, radar-based, etc., or based on a combination of multiple of such sensors (i.e. multi-modal). These existing 3D object detectors mainly rely on a bird's eye view representation, where features from multiple sensors are aggregated to construct a unified representation of the 3D object in the relevant coordinate space. However, current training processes for 3D object detectors do not specifically address false negative detections, or missed objects, which are often caused by occlusions and/or cluttered backgrounds in the given image/video. Reducing false negatives is crucial for many downstream applications, particularly autonomous driving applications which rely on accurate detection of obstacles such as pedestrians, cyclists, and other vehicles for making safe driving decisions.

There is a need for addressing these issues and/or other issues associated with the prior art. For example, there is a need to reduce false negatives in 3D object detection, which as disclosed herein can be achieved through multi-stage training of the 3D object detector.

### SUMMARY

A method, computer readable medium, and system are disclosed for multi-stage training for 3D object detection. A 3D object detector is trained to detect 3D objects from a given 3D scene representation. The training includes detecting 3D objects over at least two stages, including in a first stage of the at least two stages, detecting, by the 3D object detector, 3D objects from a 3D scene representation. The training further includes in at least one subsequent stage of the at least two stages, masking prior detected 3D objects from the 3D scene representation to form a masked 3D scene representation and detecting, by the 3D object detector, additional 3D objects from the masked 3D scene representation. The training includes determining a loss based on the 3D objects detected over the at least two stages. The training includes updating the 3D object detector based on the loss.

### BRIEF DESCRIPTION OF THE DRAWINGS

FIG. 1 illustrates a flowchart of a method for multi-stage training for 3D object detection, in accordance with an embodiment.

FIG. 2 illustrates a flowchart of a method for training a machine learning model over a plurality of stages for 3D object detection, in accordance with an embodiment.

FIG. 3 illustrates a multi-stage training pipeline for a 3D object detector, in accordance with an embodiment.

FIG. 4 illustrates a visual depiction of the multi-stage training of the 3D object detector of FIG. 3, in accordance with an embodiment.

FIG. 5 illustrates a visual depiction of the multi-stage training of FIG. 4 in the context of an autonomous driving environment, in accordance with an embodiment.

FIG. 6 illustrates a flowchart of a method for using a 3D object detector in a downstream task, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

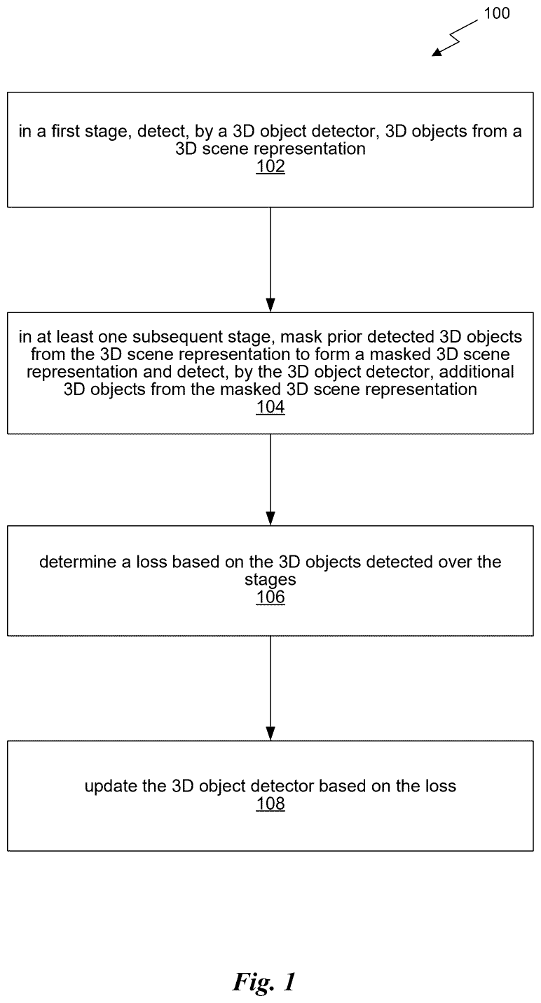

FIG. 1 illustrates a flowchart of a method 100 for multi-stage training for 3D object detection, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

The method 100 is performed to train a 3D object detector to detect 3D objects from a given 3D scene representation. With respect to the present description, a 3D object refers to any physical object located in a scene (e.g. environment) which is captured in the 3D scene representation. For example, the 3D object may be a static object (e.g. a road, intersection, building, etc.) or a moving object (e.g. a human, automobile, bicycle, etc.).

In an embodiment, the 3D object detector is a machine learning model. The machine learning model may be pretrained (e.g. on training data) to detect 3D objects. In embodiments, the 3D object detector may include an encoder and/or decoder. In any case, as disclosed herein, the 3D object detector is trained over at least two stages to detect 3D objects from a given 3D scene representation.

In operation 102, which represents a first stage of the training, the 3D object detector detects 3D objects from a 3D scene representation. The first stage refers to a stage of the training of the 3D object detector that precedes at least one subsequent stage of the training of the 3D object detector (described in operation 104). The first stage may be, but does not necessarily have to be, an initial stage of the training, in various embodiments.

The 3D scene representation refers to any type of representation of the 3D scene. In an embodiment, the 3D scene representation may include labels of the 3D objects included in the 3D scene. Thus, ground truths for the 3D scene may be predefined.

In an embodiment, the 3D scene representation may be a heatmap. In an embodiment, the 3D scene representation may be generated from a feature map, which in turn may be generated from at least one input that captures a 3D scene. In an embodiment, the feature map may combine feature maps generated from a plurality of inputs that capture the 3D scene. The input may be in any format capable of capturing the 3D scene. The input may be a lidar point cloud, an image captured by a camera, or a combination of a lidar point cloud and at least one image captured by a camera, in some examples.

As mentioned, the 3D object detector detects (e.g. one or more) 3D objects from the 3D scene representation (i.e. without use of any given labels). In an embodiment, detecting a 3D object may include detecting a location (e.g. coordinates) of the 3D object. In an embodiment, detecting a 3D object may include detecting a point on the 3D object. In an embodiment, detecting a 3D object may include detecting a center point on the 3D object. In an embodiment, detecting a 3D object may include detecting a bounding box for the 3D object.

In operation 104, which represents at least one subsequent stage of the training, prior detected 3D objects are masked from the 3D scene representation to form a masked 3D scene representation and the 3D object detector detects 3D objects from the masked 3D scene representation. Masking the prior detected 3D objects from the 3D scene representation refers to removing the prior detected 3D objects from the 3D scene representation, or otherwise preventing the prior detected 3D objects from being detected again during the subsequent detecting of 3D objects by the 3D object detector. This masking may prevent a subsequent stage from applying a loss to the prior detected 3D objects. This masking may encourage the 3D object detector to detect 3D objects that may have gone undetected in prior training stages.

To this end, after the 3D object detector detects the 3D objects in the first stage, then the detected 3D objects may be masked from the 3D scene representation for use in a next stage during which the 3D object detector detects additional 3D objects from the masked 3D scene representation. This masking and subsequent detecting process may be repeated over one or more sequential stages following the first stage, in an embodiment. This masking and subsequent detecting process may be repeated over a predefined number of stages.

For example, the at least one subsequent stage may include at least a second stage in which 3D objects detected in the first stage are masked from the 3D scene representation to form a first masked 3D scene representation and in which the 3D object detector detects additional 3D objects from the first masked 3D scene representation, and further a third stage in which the 3D objects detected in the first stage and the additional 3D objects detected in the second stage are masked from the 3D scene representation to form a second masked 3D scene representation and in which the 3D object detector detects further 3D objects from the second masked 3D scene representation.

In operation 106, a loss is determined based on the 3D objects detected over the at least two stages. The loss indicates an accuracy of the 3D object detector in detecting 3D objects in the 3D representation of the scene. In an embodiment, the loss is determined using a predefined loss function. In an embodiment, the loss is a Gaussian focal loss.

In an embodiment, the loss is determined between the 3D objects detected over the at least two stages and 3D objects labeled in a ground truth given for the 3D scene representation. For example, the training of the 3D object detector may also include accumulating 3D objects detected over the at least two stages described above, such that the loss may be determined based those detected 3D objects.

In an embodiment, the training may also include predicting bounding boxes for the 3D objects detected over the at least two stages, in which case the loss may be determined between the bounding boxes predicted for the 3D objects detected over the at least two stages and bounding boxes of the 3D objects labeled in the ground truth given for the 3D scene representation.

In operation 108, the 3D object detector is updated based on the loss. Updating the 3D object detector refers to updating one or more parameters (e.g. weights) of the 3D object detector. The 3D object detector may be updated so as to optimize (e.g. improve) an accuracy of the 3D object detector in detecting 3D object for a given 3D scene representation.

In an embodiment, an encoder of the 3D object detector may detect the 3D objects over the at least two stages. In an embodiment, a decoder of the 3D object detector may compute the loss and update the 3D object detector.

By employing the multiple stages of training as described above with respect to the method 100, the 3D object detector may be encouraged in one or more stages to detect 3D objects that may have gone undetected in the prior stages. As a result, false negative detections may probed progressively during to improve a recall rate of the 3D object detector. The trained 3D object detector may accordingly be optimized to avoid false negatives during test and/or inference time. In an embodiment, the trained 3D object detector may be used to make predictions for a downstream task (e.g. application), such as an autonomous driving application that uses the detection of 3D objects in an environment to make autonomous driving decisions.

Further embodiments will now be provided in the description of the subsequent figures. It should be noted that the embodiments disclosed herein with reference to the method 100 of FIG. 1 may apply to and/or be used in combination with any of the embodiments of the remaining figures below.

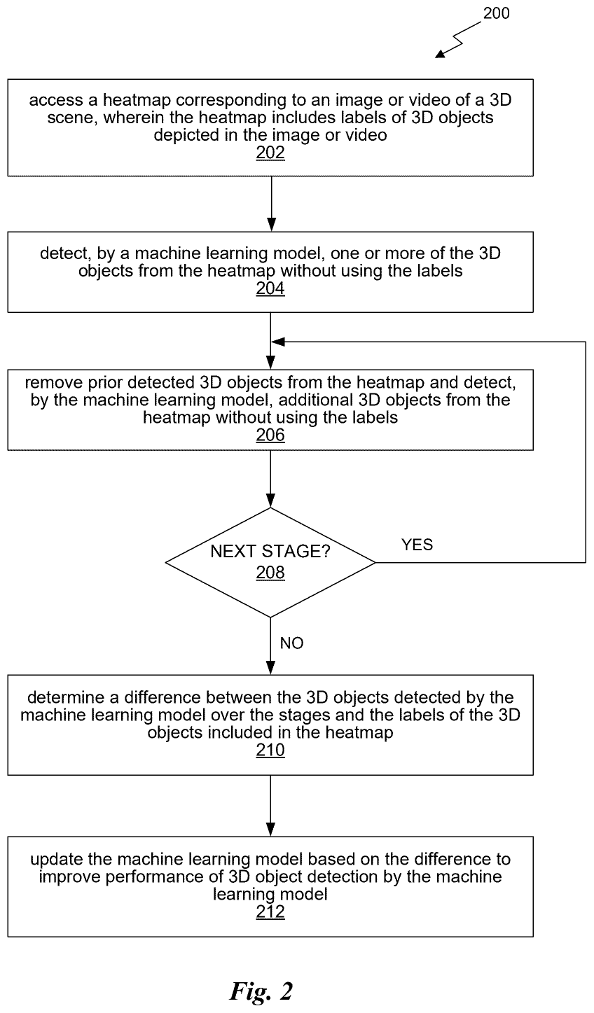

FIG. 2 illustrates a flowchart of a method 200 for training a machine learning model over a plurality of stages for 3D object detection, in accordance with an embodiment. In an embodiment, the machine learning model may be the 3D object detector described in FIG. 1. Thus, the method 200 may be carried out in the context of the method 100 of FIG. 1, in an embodiment. The descriptions and definitions provided above may equally apply to the present embodiments.

In operation 202, a heatmap corresponding to an image or video of a 3D scene is accessed, where the heatmap includes labels of the 3D objects depicted in the image or video. The labels may represent ground truths for the 3D objects included in the 3D scene. In an embodiment, the labels of the 3D objects may indicate a location of the 3D objects depicted in the image or video. In an embodiment, the labels of the 3D objects may indicate a classification of the 3D objects depicted in the image or video.

In an embodiment, the heatmap may be generated from a feature map. The feature map may be generated from at least one input that captures the 3D scene, such as a lidar point cloud and/or an image captured by a camera. In an embodiment, the feature map may combine feature maps generated from a plurality of inputs that capture the 3D scene, such as a plurality of images captured by cameras with different perspectives of the 3D scene.

In operation 204, a machine learning model detects one or more of the 3D objects from the heatmap without using the labels. This may be referred to as a first stage of detection. The machine learning model may be pretrained (e.g. on a training data set) to perform the 3D object detection from a given heatmap. In an embodiment, the machine learning model may determine a location of 3D objects from the heatmap without using the labels. In an embodiment, the machine learning model may further determine a classification of 3D objects from the heatmap without using the labels.

In operation 206, prior detected 3D objects are removed from the heatmap and the machine learning model detects one or more additional 3D objects from the heatmap without using the labels. This may be referred to as a second stage of detection. In decision 208, it is determined whether a next stage of processing is to be performed. This decision may be made based on predefined number of stages to be performed.

When it is determined that a next stage of processing is to be performed, then the method 200 returns to operation 206. When it is determined that a next stage of processing is not to be performed, then the method 200 proceeds to operation 210 in which a difference is determined between the 3D objects detected by the machine learning model and the labels of the 3D objects included in the heatmap. In other words, a loss is determined based on the 3D objects detected by the machine learning model in view of the ground truths given for the heatmap.

In operation 212, the machine learning model is updated based on the difference to improve performance of the 3D object detection by the machine learning model. For example, weights of the machine learning model may be updated. To this end, the method 200 may multi-stage process for training the machine learning model to be able to detect 3D objects without false negatives.

The trained machine learning model may then be used for one or more downstream tasks. In an embodiment, the trained machine learning model may be usable to detect obstacles in a driving environment of an autonomous driving application and to input those obstacles to an autonomous driving application for use in making one more autonomous driving decisions.

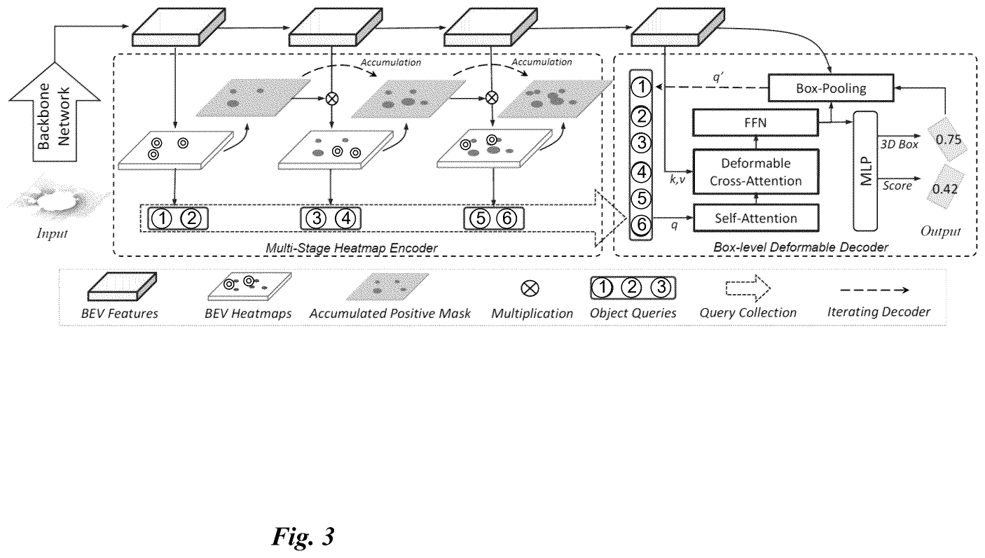

FIG. 3 illustrates a multi-stage training pipeline for a 3D object detector, in accordance with an embodiment. The 3D object detector may be that described above with reference to any of the figures described above. Thus, the descriptions and definitions provided above may equally apply to the present embodiments.

Real-world applications, such as autonomous driving, require a high level of scene understanding to ensure safe and secure operation. In particular, false negatives in object detection can present severe risks, emphasizing the need for high recall rates. However, accurately identifying objects in complex scenes or when occlusion occurs is challenging in 3D object detection, resulting in many false negative predictions.

The illustrated training pipeline aims to emulate the process of identifying false negative predictions at inference time. 3D objects that may otherwise be missed by a 3D object detector (i.e. false negatives) are described herein as “hard instances.” The pipeline identifies hard instances stage by stage.

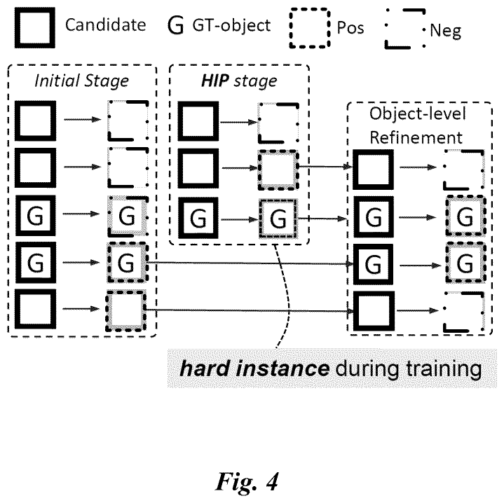

This hard instance probing is shown in FIG. 4, where the symbol “G” is used to indicate the object candidates that are labeled as ground-truth objects during the target assignment process in training. To ensure clarity, numerous negative predictions are omitted for detection, given that the background takes up most of the images.

Returning to FIG. 3, initially, a ground truth objects are annotated per 0={oᵢ, i=1, 2, . . . }, which is the main targets for initial stages. The neural network makes positive or negative predictions given a set of initial object candidates A={aᵢ, i=1, 2, . . . }, which is not limited to anchors, point-based anchors, and object queries. Suppose the detected objects (positive predictions) at k-th stage are Pₖ={pᵢ, i=1, 2, . . . }. The ground-truth objects can then be classified according to their assigned candidates:

$${O}_{k}^{TP} = \{ {o}_{j} \vert ∃ {p}_{i} ∈ {P}_{k} , σ ( {p}_{i} , {o}_{j} ) > η \}$$

where an object matching metric σ(·,·) (e.g. Intersection over Union and center distance) and a predefined threshold η. Thus, the left unmatched targets can be regarded as hard instances:

$${O}_{k}^{FN} = O - {⋃}_{i = 1}^{k} {O}_{k}^{TP} .$$

The training of (k+1)-th stages is to detect these targets Oₖ^{FN} EN from the object candidates while omitting all prior positive object candidates.

Despite the cascade way mimicking the process of identifying false negative samples, a number of object candidates may be collected across all stages. Thus, a second-stage object-level refinement model may be used to eliminate any potential false positives. To this end, false negative predictions from prior stages are used to guide the subsequent stage of the model toward learning from these challenging objects.

### Multi-Stage Heatmap Encoder for Bird's Eye View (BEV) Detection

Hard instance probing for BEV detection involves using the BEV center heatmap to generate the initial object candidate in a cascade manner.

The objective of the BEV heatmap head is to produce heatmap peaks at the center locations of detected objects. The BEV heatmaps are represented by a tensor SϵR^{X×Y×C}, where X×Y indicates the size of the BEV feature map and C is the number of object categories. The target is achieved by producing 2D Gaussians near the BEV object points, which are obtained by projecting 3D box centers onto the map view. In top views, objects are more sparsely distributed than in a 2D image. Moreover, it is assumed that objects do not have intra-class overlaps on the bird's eye view.

Based on the non-overlapping assumption, excluding prior easy positive candidates from BEV heatmap predictions can be achieved. In the following, the details of hard instance probing are disclosure, which utilizes an accumulated positive mask.

To keep track of all easy positive object candidates of prior stages, a positive mask (PM) is generated on the BEV space for each stage and they are accumulated to an accumulated positive mask (APM): \hat{M}ₖϵ{0,1}^{X×Y×C}, which is initialized as all zeros.

The generation of multi-stage BEV features is accomplished in a cascade manner using a lightweight inversed residual block between stages. Multi-stage BEV heatmaps are generated by adding an extra convolution layer. At each stage, the positive mask is generated according to the positive predictions. To emulate the process of identifying false negatives, a test-time selection strategy is used that ranks the scores according to BEV heatmap response. Specifically, at the k-th stage, Top-K selection is performed on the BEV heatmap across all BEV positions and categories, producing a set of object predictions Pₖ. Then the positive mask Mₖϵ{0,1}^{X×Y×C} records all the positions of positive predictions by setting M(x, y, c)=1 for each predicted object pᵢϵPₖ, where (x,y) represents pᵢ's location and c is pᵢ's class. The left points are set to 0 by default.

According to the non-overlapping assumption, one to indicate the existence of a positive object candidate (represented as a point in the center heatmap) on the mask is by masking the box if there is a matched ground truth box. However, when the ground-truth boxes are not available at inference time, the following masking methods may be used during training:
1. Point Masking. This method involves no change, where only the center point of the positive candidates is filled.
2. Pooling-based Masking. In this method, smaller objects fill in the center points while larger objects fill in with a kernel size of 3×3.
3. Box Masking. This method requires an additional box prediction branch and involves filling the internal region of the predicted BEV box.

The accumulated positive mask (APM) for the k-th stage is obtained by accumulating prior positive masks as follows:

$${\hat{M}}_{k} = \begin{matrix}max \\ 1 \leq i \leq k\end{matrix} {M}_{i} .$$

By masking the BEV heatmap Sₖ with Ŝₖ=Sₖ·(1−\hat{M}ₖ), prior easy positive regions are omitted in the current stage, thus enabling the model to focus on the false negative samples of the prior stage (hard instances). To train the multi-stage heatmap encoder, Gaussian Focal Loss is adopted as the training loss function. The BEV heatmap losses are summed up across stages to obtain the final heatmap loss.

During both training and inference, the positive candidates are collected from all stages as the object candidates for the second-stage rescoring as the potential false positive predictions.

### Box-Level Deformable Decoder

The object candidates obtained from the multi-stage heatmap encoder can be treated as positional object queries. The recall of initial candidates improves with an increase in the number of collected candidates. However, redundant candidates introduce false positives, thereby necessitating a high level of performance for the following object-level refinement blocks.

To enhance the efficiency of object query processing, deformable attention is employed instead of computationally intensive modules such as cross attention or box attention. The object candidates are modeled as box-level queries. Specifically, object supervision is introduced between deformable decoder layers, facilitating relative box prediction.

### Box-Pooling Module

To better model the relations between objects and local regions in the regular grid manner, the box context information is extracted from the BEV features using simple RoIAlign in the Box-pooling module. Given the intermediate predicted box, each object query extracts 7×7 feature grid points from the BEV map followed by two MLP layers. The positional encoding is also applied both for queries and all BEV points for extracting positional information. This allows both the content and positional information to be updated into the query embedding. This lightweight module enhances the query feature for the deformable decoder.

### Example Decoder Implementation

The model employs 8 heads in all attention modules, including multi-head attention and multi-head deformable attention. The deformable attention utilizes 4 sampling points across 3 scales. To generate three scales of BEV features, 2× and 4× downsampling operations are applied to the original BEV features. The box-pooling module extracts 7×7 feature grid points within each rotated BEV box followed by 2 FC layers and adds the object feature to query embedding. The predicted box is expanded to 1.2× size of its original size.

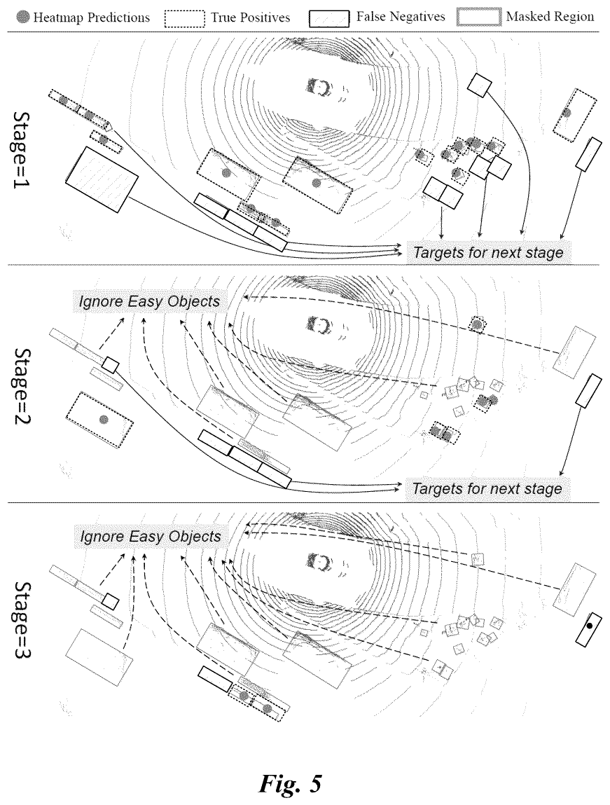

FIG. 5 illustrates a visual depiction of the multi-stage training of FIG. 4 in the context of an autonomous driving environment, in accordance with an embodiment.

By utilizing this multi-stage prediction approach disclosed in the embodiments above, the model can progressively focus on hard instances and facilitate its ability to gradually detect them. At each stage, the model generates some positive object candidates. Object candidates assigned to the ground-truth objects can be classified as either True Positives (TP) and False Negatives (FN) during training. The unmatched ground-truth objects are explicitly modeled as the hard instances, which become the main targets for the subsequent stage.

Conversely, Positives are considered easy samples and will be ignored in subsequent stages at both training and inference time. At last, all heatmap predictions across stages are collected as the initial object candidates. The False Positives are ignored for better visualizations in the present example.

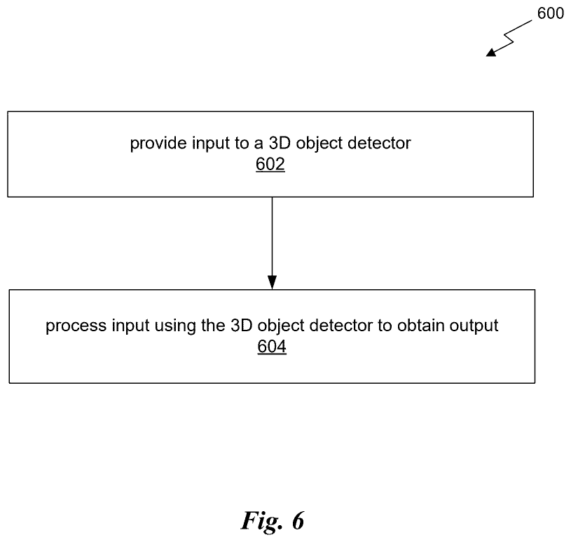

FIG. 6 illustrates a flowchart of a method 600 for using a 3D object detector in a downstream task, in accordance with an embodiment. The method 600 may be performed using the 3D object detector disclosed per any of the methods and/or systems described above. The definitions and embodiments described above may equally apply to the description of the present embodiment.

In operation 602, input is provided to a 3D object detector. The input may be any data intended for processing by the 3D object detector. In an embodiment, the input may be in a format which the 3D object detector is configured to be able to process (e.g. a 3D representation of a scene).

In operation 604, the input is processed by the 3D object detector to obtain output. The input may be processed using the values of the 3D object detector and other features of the 3D object detector such as the channels, layers, etc. In an embodiment, the 3D object detector is trained to detect 3D objects given an input. Thus, the output is a prediction or inference made by the 3D object detector based upon the input.

The output may be provided as input to the downstream task. The downstream task may be an autonomous driving application, a robotic control application, or any other application configured to perform some operation(s) as a function of 3D objects detected by the 3D object detector.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

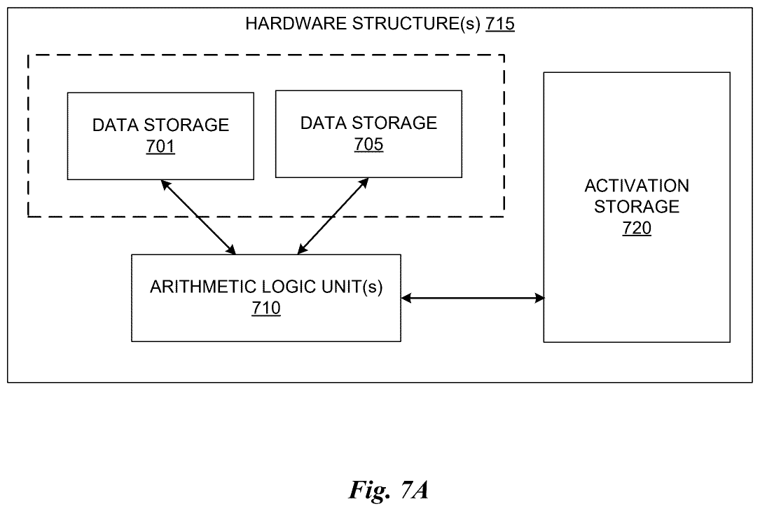

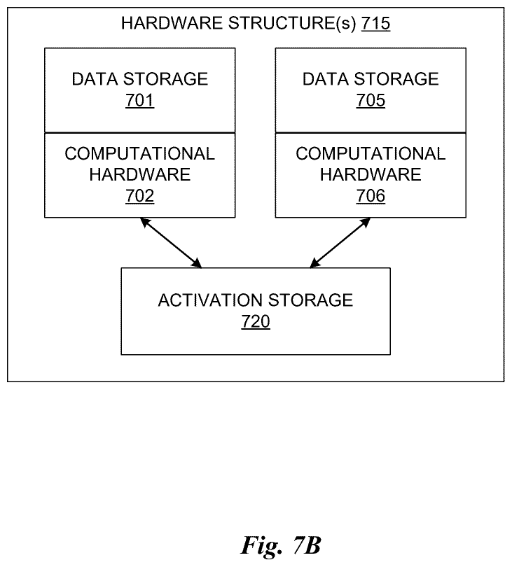

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

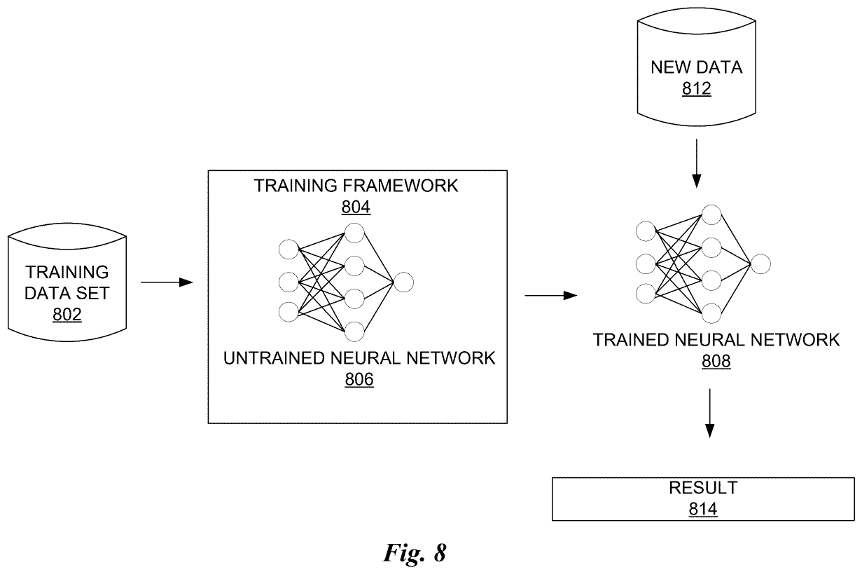

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

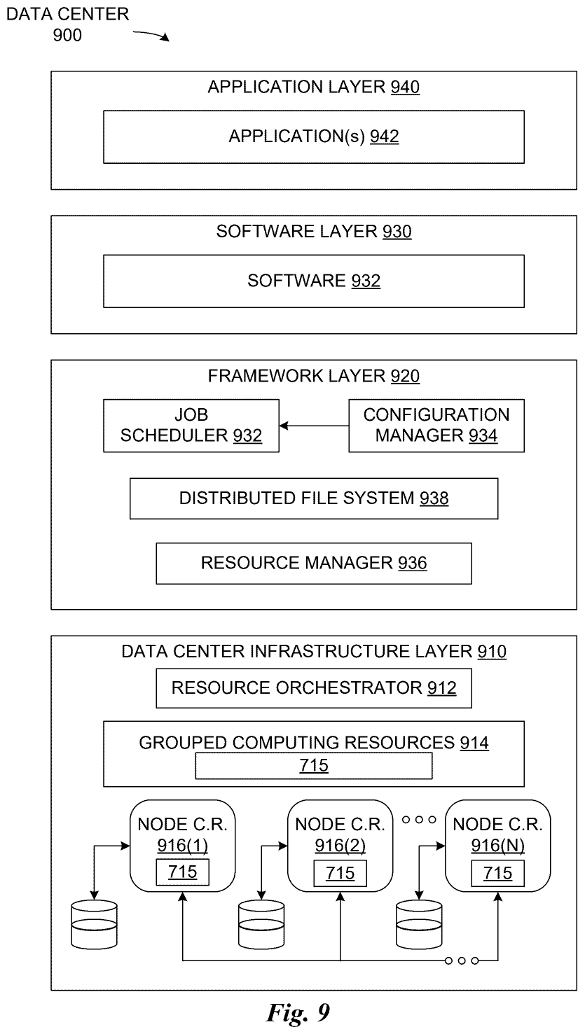

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for training a 3D object detector. In accordance with FIGS. 1-6, embodiments may provide the 3D object detector as a machine learning model usable for performing inferencing operations and for providing inferenced data. The 3D object detector may be stored (partially or wholly) in one or both of data storage 701 and 705 in inference and/or training logic 715 as depicted in FIGS. 7A and 7B. Training and deployment of the 3D object detector may be performed as depicted in FIG. 8 and described herein. Distribution of the 3D object detector may be performed using one or more servers in a data center 900 as depicted in FIG. 9 and described herein.

What is claimed is:

1. A method, comprising:
at a device, training a machine learning model to be able to detect 3D objects in a given image or video, wherein the training of the machine learning model is performed over a plurality of stages, including:
accessing a heatmap corresponding to an image or video of a 3D scene, wherein the heatmap includes labels of 3D objects depicted in the image or video;
in an initial stage, detecting, by the machine learning model, one or more of the 3D objects from the heatmap without using the labels;
in at least one subsequent stage, removing prior detected 3D objects from the heatmap to form a masked heatmap and detecting, by the machine learning model, additional 3D objects from the masked heatmap without using the labels;
determining a difference between the 3D objects detected by the machine learning model over the plurality of stages and the labels of the 3D objects included in the heatmap; and
updating the machine learning model based on the difference to improve performance of 3D object detection by the machine learning model.

2. The method of claim 1, wherein the labels of the 3D objects indicate a location of the 3D objects depicted in the image or video.

3. The method of claim 2, wherein the machine learning model determines a location of 3D objects from the heatmap without using the labels.

4. The method of claim 3, wherein the labels of the 3D objects indicate a classification of the 3D objects depicted in the image or video.

5. The method of claim 4, wherein the machine learning model further determines a classification of 3D objects from the heatmap without using the labels.

6. The method of claim 1, wherein the trained machine learning model is usable to detect obstacles in a driving environment of an autonomous driving application and to input those obstacles to an autonomous driving application for use in making one more autonomous driving decisions.

7. A method, comprising:
at a device, training a three-dimensional (3D) object detector to detect 3D objects from a given 3D scene representation, wherein the training includes detecting 3D objects over at least two stages, including:
in a first stage of the at least two stages, detecting, by the 3D object detector, 3D objects from a 3D scene representation;
in at least one subsequent stage of the at least two stages, masking prior detected 3D objects from the 3D scene representation to form a masked 3D scene representation and detecting, by the 3D object detector, additional 3D objects from the masked 3D scene representation;
determining a loss based on the 3D objects detected over the at least two stages; and
updating the 3D object detector based on the loss.

8. The method of claim 7, wherein the 3D scene representation is a heatmap.

9. The method of claim 7, wherein the 3D scene representation is generated from a feature map.

10. The method of claim 9, wherein the feature map is generated from at least one input that captures a 3D scene.

11. The method of claim 10, wherein the feature map combines feature maps generated from a plurality of inputs that capture the 3D scene.

12. The method of claim 10, wherein the input includes a lidar point cloud.

13. The method of claim 10, wherein the input includes an image captured by a camera.

14. The method of claim 10, wherein the input includes a lidar point cloud and at least one image captured by a camera.

15. The method of claim 7, wherein detecting the 3D objects includes detecting a location of the 3D objects.

16. The method of claim 7, wherein detecting the 3D objects includes detecting a point on the 3D objects.

17. The method of claim 7, wherein detecting the 3D objects includes detecting a center point on the 3D objects.

18. The method of claim 7, wherein masking the prior detected 3D objects from the 3D scene representation includes removing the prior detected 3D objects from the 3D scene representation.

19. The method of claim 7, wherein the at least one subsequent stage includes at least:
a second stage in which 3D objects detected in the first stage are masked from the 3D scene representation to form a first masked 3D scene representation and in which the 3D object detector detects additional 3D objects from the first masked 3D scene representation; and
a third stage in which the 3D objects detected in the first stage and the additional 3D objects detected in the second stage are masked from the 3D scene representation to form a second masked 3D scene representation and in which the 3D object detector detects further 3D objects from the second masked 3D scene representation.

20. The method of claim 7, wherein masking the prior detected 3D objects from the 3D scene representation prevents a subsequent stage from applying a loss to those prior detected 3D objects.

21. The method of claim 7, wherein training the 3D object detector further includes:
accumulating 3D objects detected over the at least two stages.

22. The method of claim 7, wherein an encoder of the 3D object detector detects the 3D objects over the at least two stages.

23. The method of claim 7, wherein the loss is determined between the 3D objects detected over the at least two stages and 3D objects labeled in a ground truth given for the 3D scene representation.

24. The method of claim 23, wherein the loss is a Gaussian focal loss.

25. The method of claim 23, wherein training the 3D object detector further includes:
predicting bounding boxes for the 3D objects detected over the at least two stages;
wherein the loss is determined between the bounding boxes predicted for the 3D objects detected over the at least two stages and bounding boxes of the 3D objects labeled in the ground truth given for the 3D scene representation.

26. The method of claim 23, wherein a decoder of the 3D object detector determines the loss and updates the 3D object detector.

27. A system, comprising:
a non-transitory memory storage comprising instructions; and
one or more processors in communication with the memory, wherein the one or more processors execute the instructions to train a three-dimensional (3D) object detector to detect 3D objects from a given 3D scene representation, wherein the training includes detecting 3D objects over at least two stages, including:
in a first stage of the at least two stages, detecting, by the 3D object detector, 3D objects from a 3D scene representation;
in at least one subsequent stage of the at least two stages, masking prior detected 3D objects from the 3D scene representation to form a masked 3D scene representation and detecting, by the 3D object detector, additional 3D objects from the masked 3D scene representation;
determining a loss based on the 3D objects detected over the at least two stages; and
updating the 3D object detector based on the loss.

28. The system of claim 27, wherein the 3D scene representation is a heatmap.

29. The system of claim 27, wherein the 3D scene representation is generated from a feature map.

30. The system of claim 29, wherein the feature map is generated from at least one input that captures a 3D scene.

31. The system of claim 30, wherein the input includes at least one of a lidar point cloud or an image captured by a camera.

32. The system of claim 27, wherein detecting the 3D objects includes detecting one of:
a location of the 3D objects,
a point on the 3D objects, or
a center point on the 3D objects.

33. The system of claim 27, wherein masking the prior detected 3D objects from the 3D scene representation includes removing the prior detected 3D objects from the 3D scene representation.

34. The system of claim 27, wherein masking the prior detected 3D objects from the 3D scene representation prevents a subsequent stage from applying a loss to those prior detected 3D objects.

35. The system of claim 27, wherein the loss is determined between the 3D objects detected over the at least two stages and 3D objects labeled in a ground truth given for the 3D scene representation.

36. The system of claim 35, wherein the loss is a Gaussian focal loss.

37. The system of claim 35, wherein training the 3D object detector further includes:
predicting bounding boxes for the 3D objects detected over the at least two stages;
wherein the loss is determined between the bounding boxes predicted for the 3D objects detected over the at least two stages and bounding boxes of the 3D objects labeled in the ground truth given for the 3D scene representation.

38. A non-transitory computer-readable media storing computer instructions which when executed by one or more processors of a device cause the device to train a three-dimensional (3D) object detector to detect 3D objects from a given 3D scene representation, wherein the training includes detecting 3D objects over at least two stages, including:
in a first stage of the at least two stages, detecting, by the 3D object detector, 3D objects from a 3D scene representation;
in at least one subsequent stage of the at least two stages, masking prior detected 3D objects from the 3D scene representation to form a masked 3D scene representation and detecting, by the 3D object detector, additional 3D objects from the masked 3D scene representation;
determining a loss based on the 3D objects detected over the at least two stages; and
updating the 3D object detector based on the loss.

39. The non-transitory computer-readable media of claim 38, wherein the 3D scene representation is a heatmap.

40. The non-transitory computer-readable media of claim 38, wherein the 3D scene representation is generated from a feature map.

41. The non-transitory computer-readable media of claim 40, wherein the feature map is generated from at least one input that captures a 3D scene, and wherein the input includes at least one of a lidar point cloud or an image captured by a camera.

42. The non-transitory computer-readable media of claim 38, wherein detecting the 3D objects includes detecting one of:
a location of the 3D objects,
a point on the 3D objects, or
a center point on the 3D objects.

43. The non-transitory computer-readable media of claim 38, wherein masking the prior detected 3D objects from the 3D scene representation prevents a subsequent stage from applying a loss to those prior detected 3D objects.

44. The non-transitory computer-readable media of claim 38, wherein the loss is determined between the 3D objects detected over the at least two stages and 3D objects labeled in a ground truth given for the 3D scene representation.

45. The non-transitory computer-readable media of claim 44, wherein training the 3D object detector further includes:
predicting bounding boxes for the 3D objects detected over the at least two stages;
wherein the loss is determined between the bounding boxes predicted for the 3D objects detected over the at least two stages and bounding boxes of the 3D objects labeled in the ground truth given for the 3D scene representation.
